(19) United States
(12) Patent Application Publication
(10) Pub. No.: US 2026/0216657 A1
(43) Pub. Date: Jul. 30, 2026

(54) NANOFILTRATION MEMBRANE BASED ON CARBON NANOTUBE FIBERS AND METHOD FOR FABRICATING THE SAME

(71) Applicant: INSTITUTE OF PHYSICS, CHINESE ACADEMY OF SCIENCES, Beijing (CN)

(72) Inventors: Nuo XU, Beijing (CN); Xiao Zhang, Beijing (CN); Weiya Zhou, Beijing (CN); Huaping Liu, Beijing (CN); Yanchun Wang, Beijing (CN)

(21) Appl. No.: 19/457,283

(22) Filed: Jan. 23, 2026

(30) Foreign Application Priority Data
Jan. 27, 2025 (CN) 202510126137.X

(51) Int. Cl. B01D 67/00; B01D 61/02; B01D 71/02; C01B 32/16

(52) U.S. Cl. CPC B01D 67/00793; B01D 61/027; B01D 67/0088; B01D 71/0212; C01B 32/16; B01D 2323/46; B01D 2323/62

(57) ABSTRACT

Provided are a nanofiltration membrane based on carbon nanotube fibers (CNTFs) and a method for fabricating the same. The method includes: embedding one or more CNTF(s) in a resin to form an embedded block; and slicing the embedded block to obtain a nanofiltration membrane of target thickness, with cross-sections of CNTs exposed on both surfaces of the nanofiltration membrane. By first embedding the CNTFs in resin and then slicing the resulting block to the desired thickness, facile fabrication of a CNTF-based nanofiltration membrane is realized. Since a CNTF is a macroscopic assemblage of CNTs, every cross-section of the CNTF contains a dense array of CNT pores that act as inlet/outlet ports for molecular transport. Because both surfaces of the sliced membrane expose these CNTF cross-sections, the carbon nanotubes traverse the entire membrane thickness, markedly increasing the number of effective transport channels and thereby delivering high flux.

### CROSS-REFERENCE TO RELATED APPLICATIONS

The present application claims priority to Chinese patent application No. 202510126137.X entitled “Nanofiltration Membrane Based on Carbon Nanotube Fibers and Method for Fabricating the Same”, filed on January 27, 2025, the entire contents of which are incorporated herein by reference.

### TECHNICAL FIELD

The present invention relates to the field of membrane separation technology, and in particular to a nanofiltration membrane based on carbon nanotube fibers (CNTFs) and a method for fabricating the same.

### BACKGROUND

Filtration membranes can achieve separation and sieving of substances through interactions such as size exclusion and electrostatic repulsion. Nanofiltration membranes, characteristic dimensions of which are on the nanometer scale, can reject nanometer-sized impurities while transporting target substances, and are therefore widely used in the chemical and pharmaceutical industries as well as in everyday life.

Conventional nanofiltration membranes are composed of long-chain polymeric fibers that are interwoven to form a tight three-dimensional network. The tortuous channels created within this stacked network constitute the transport pathways of the membrane. However, such conventional membranes suffer from the following drawbacks:

1. The long-chain polymeric fibers themselves possess poor structural stability and corrosion resistance, limiting the applicable environments thereof.

2. The channels formed by a stacked three-dimensional network are prone to compaction during prolonged operation, leading to changes in pore size and consequently to variations in separation and transport performance in actual use.

3. The tortuous channels result in long transport distances and high resistance; and thus actual transport relies on a solution-diffusion mechanism of substances within the membrane, giving rise to high resistance and low flux.

To overcome the above problems, nanofiltration membranes based on carbon nanotubes (CNTs) have been developed. CNTs, with their inherent tubular structure and stable physicochemical properties, constitute ideal transport channels. Both experiments and simulations have revealed that the interior space of CNTs exhibits super-fast transport for water molecules, and the inner diameter of CNTs, which is controllable by catalyst size, offers the potential for tunable pore size in nanofiltration membrane, attracting widespread attention.

At present, two main routes are pursued to fabricate nanofiltration membranes based on CNTs.

Route 1 employs vertical aligned CNT arrays grown on silicon wafers. Membranes derived from such arrays have demonstrated pure-water permeabilities as high as 200 L·m⁻²·h⁻¹·bar⁻¹, exceeding those of conventional nanofiltration and ultrafiltration membranes of comparable pore size. However, precise control of the CNT diameter inside the vertical array is difficult, and the intrinsic tortuosity of the CNT array cannot be reduced by post-treatment, which leads to degradation of separation and transport efficiency. Moreover, the size of the vertical CNT array grown on the silicon wafer is limited, resulting in low efficiency in fabricating membranes.

Route 2 uses dispersions of CNTs with controllable inner diameters as a starting material. This approach partly overcomes the limitations of diameter tunability and filtration membrane size, yet the low concentration of current CNT dispersions, the short length of dispersed CNTs, and high defect density in the wall of CNTs lead to low surface density of CNTs in the nanofiltration membrane. More critically, membranes produced from CNT dispersions cannot ensure that CNTs traverse the entire membrane thickness in a well-aligned manner, further reducing the number of effective CNT channels.

Consequently, both vertical aligned arrays and CNT dispersion routes face a trade-off between selective separation and the effective membrane area (number of through membrane channels). There is therefore an urgent need for a new fabrication strategy that fully exploits the advantages of CNT-based nanofiltration membranes-namely, controllable pore size, high permeability, and superior chemical stability-over traditional polymeric membranes.

### SUMMARY

In view of the above problems, the present invention provides a nanofiltration membrane based on CNTFs and a method for fabricating the same, which overcome or at least partially solve the afore-mentioned drawbacks.

An object of the present invention is to provide a simple method for fabricating a high flux nanofiltration membrane based on CNTFs (CNTF-NM).

A further object of the present invention is to further increase the flux of the nanofiltration membrane.

Still a further object of the present invention is to achieve effective regulation of the selectivity of the nanofiltration membrane, thereby realizing a tunable-selectivity nanofiltration membrane.

In particular, and in accordance with one aspect of the present invention, there is provided a method for fabricating a nanofiltration membrane based on CNTFs, including: embedding one or more carbon-nanotube fibers in a resin to form an embedded block; and slicing the embedded block to obtain a nanofiltration membrane of target thickness, with cross-sections of carbon nanotubes exposed on both surfaces of the nanofiltration membrane.

Optionally, the step of embedding one or more carbon-nanotube fibers in a resin to form an embedded block includes: placing the one or more carbon-nanotube fibers in a desired orientation in a container; and adding the resin into the container and curing it to embed the one or more carbon-nanotube fibers to obtain the embedded block.

Optionally, the step of placing the one or more carbon-nanotube fibers in a desired orientation in a container includes: fixing the one or more carbon-nanotube fibers in a frame with at least a portion of the one or more carbon-nanotube fibers being not in direct contact with the frame; and inserting the frame vertically into the container along a longitudinal direction of the frame.

Optionally, the one or more carbon-nanotube fibers are in a form of a single CNTF, an array formed by a plurality of CNTFs, or a bundle-like structure formed by twisting one or more CNTFs.

Optionally, in a case that the one or more carbon-nanotube fibers are in the form of the single CNTF or the array formed by a plurality of CNTFs, the frame has a cross-beam, and at least a part of the single CNTF or of each carbon-nanotube fiber of the array is fixed on the cross-beam so that the single CNTF or each carbon-nanotube fiber of the array extends along the longitudinal direction of the frame, wherein the step of slicing the embedded block includes: performing stepwise slicing on the embedded block with a cutting plane perpendicular to an axial direction of the carbon-nanotube fiber, with a step length being the target thickness of the CNTF-NM.

Optionally, in a case that the one or more carbon-nanotube fibers are in the form of the bundle-like structure formed by twisting one or more CNTFs, the bundle-like structure is fixed in the frame with an axial direction of the bundle-like structure being perpendicular to the longitudinal direction of the frame; wherein the step of slicing the embedded block includes: performing stepwise slicing on the embedded block with a cutting plane parallel to an axial direction of the bundle-like structure, with a step length being the target thickness of the CNTF-NM.

Optionally, after slicing the embedded block, the method further includes: selecting an extension membrane made of a solvent-impermeable material, and forming an aperture in the extension membrane, a size of the aperture being large enough to fully expose the cross-sections of the carbon nanotubes in the CNTF-NM and smaller than a size of the CNTF-NM; and aligning the cross-sections of the carbon nanotubes in the CNTF-NM with the aperture and bonding the CNTF-NM to the extension membrane to complete extension of the CNTF-NM.

Optionally, the method further includes: treating both surfaces of the nanofiltration membrane by reactive-ion etching, ion milling, or focused ion beam cutting.

Optionally, the CNTFs are prepared by floating catalyst chemical vapor deposition (FCCVD), array spinning, wet spinning, or film twisting.

In FCCVD or array spinning, an inner diameter of carbon nanotubes in the carbon-nanotube fibers is tuned by adjusting an effective size of catalyst particles during CNT growth.

In film twisting, CNT films with different inner diameters of carbon nanotubes are selected and twisted into the carbon-nanotube fibers.

In wet spinning, the inner diameter of carbon nanotubes is tuned by selecting CNT raw materials of different diameters.

Optionally, before embedding the one or more carbon-nanotube fibers in the resin to form the embedded block, the method further includes: drawing the one or more carbon-nanotube fibers to elongate their length by a predetermined ratio of 10 %–80%.

According to another aspect of the present invention, there is also provided a nanofiltration membrane based on CNTFs prepared by the foregoing method.

The method provided by the present invention achieves facile fabrication of a CNTF-NM by first embedding CNTFs in a resin and then slicing the embedded block to obtain a nanofiltration membrane of target thickness. Because a CNTF is a macroscopic assemblage of CNTs, every cross-section perpendicular to the axial direction of the CNTF contains a large number of CNT pores that can serve as inlets/outlets for mass transport. The sliced membrane exposes CNTF cross-sections on both surfaces, ensuring that the CNTs traverse the entire membrane thickness, thereby markedly increasing the number of effective channels of the membrane to deliver high flux.

Furthermore, by embedding and slicing an array of multiple CNTFs or a bundle-like structure twisted from one or more CNTFs, the method multiplies the areal density of CNTs on the membrane, giving an additional boost to membrane flux.

Still further, in the method, the effective regulation and control of the selectivity of the nanofiltration membrane can be achieved by tuning the inner diameter of the CNTs during CNT fiber preparation and then fabricating the nanofiltration membranes using CNT fibers containing CNTs of different inner diameters, thereby enabling the fabrication of tunable-selectivity CNTF-based nanofiltration membranes.

Still further, by drawing CNTFs before embedding the CNTFs, CNT tortuosity in the CNTFs is reduced and CNT packing density is increased, increasing the areal density of transport channels in the nanofiltration membrane and thus further enhancing the flux of the nanofiltration membrane.

The above and other objectives, advantages, and features of the present invention will be better understood by those skilled in the art according to the following detailed description of specific embodiments of the present invention in conjunction with the accompanying drawings.

### BRIEF DESCRIPTION OF THE DRAWINGS

A further reading of the detailed description of the preferred embodiments below will make various other advantages and benefits apparent to those of ordinary skill in the art. The accompanying drawings are provided solely to illustrate the preferred embodiments and are not considered as limiting the present invention. Throughout the drawings, identical reference numerals are used to designate identical parts. In the drawings:

FIG. 1 is a flow diagram illustrating a method for fabricating a CNTF-NM according to an embodiment of the present invention;

FIG. 2 is a schematic illustration of the preparation of an embedded block according to an embodiment of the present invention;

FIG. 3 is a schematic illustration of slicing the embedded block according to an embodiment of the present invention;

FIG. 4 is a schematic illustration of fixing an array formed by a plurality of CNTFs in a frame according to an embodiment of the present invention;

FIG. 5 is a schematic illustration of fixing a bundle-like structure formed by twisting one or more CNTFs in a frame and embedding the same according to an embodiment of the present invention;

FIG. 6 is a schematic illustration of extending the CNTF-NM according to an embodiment of the present invention;

FIG. 7 is a comparison graph of the rejection performance against Rhodamine B of CNTF-NMs based on CNTFs prepared by different catalyst feeding manners according to an embodiment of the present invention;

FIG. 8 is a schematic illustration of drawing CNTFs according to an embodiment of the present invention;

FIGS. 9a and 9b are SEM images of drawn CNTFs according to an embodiment of the present invention and of CNT bundles in a CNT array of the prior art, respectively;

FIG. 10 is a comparison graph of the flux of CNTF-NM prepared from drawn CNTFs versus the flux of CNTF-NM prepared from undrawn CNTFs according to an embodiment of the present invention;

FIG. 11 is a schematic illustration of the trans-membrane ionic conductance of the CNTF-NM according to an embodiment of the present invention;

FIG. 12 is surface SEM images of the nanofiltration membranes based on CNTFs according to an embodiment of the present invention;

FIGS. 13a and 13b are surface SEM images showing the areal density of the nanofiltration membrane based on CNTFs according to an embodiment of the present invention and of a nanofiltration membrane prepared from a CNT dispersion of the prior art, respectively.

### DETAILED DESCRIPTION OF THE EMBODIMENTS

It will be understood by those skilled in the art that the embodiments described below represent only some examples of the invention and do not encompass the full scope of the invention. The embodiments are provided solely for illustrating the technical principles of the invention and shall not be construed as limiting. Other embodiments that can be conceived by a person skilled in the art based on the present disclosure, without inventive effort, fall within the scope of the invention.

Conventional CNT-based nanofiltration membranes suffer from at least the following drawbacks: (i) vertical aligned CNT arrays allow limited tuning of CNT inner diameter, resulting in poor selectivity; (ii) membranes fabricated from CNT dispersions exhibit low CNT areal density (<10¹¹ cm⁻²) and poor alignment of CNTs across the membrane thickness, resulting in reduced permeability.

CNT-based nanofiltration membranes exhibit higher flux than conventional nanofiltration or ultrafiltration membranes. However, membranes prepared from vertically aligned CNT arrays have inherent limitations, including limited ability to precisely control the inner diameter of CNTs and few available post-treatment options for reducing CNT tortuosity.

Membranes produced from CNT dispersions allow inner-diameter control but suffer from dilute dispersions and the difficulty in aligning CNTs across the entire membrane thickness, which makes low CNTs areal density in the membrane, resulting in low flux.

In order to address these issues and improve the performance of CNT-based nanofiltration membranes, the inventors select CNTFs as the raw material.

By taking full advantage of the tunable CNT inner diameter, the highly ordered mesoscopic structure, and the industrial scalability of CNTFs, the present invention provides a method for fabricating high-flux, tunable-selectivity nanofiltration membrane based on CNTFs to overcome the specific challenges associated with CNT-based nanofiltration membranes, thus increasing the selectivity and flux of the nanofiltration membrane and improve the fabrication efficiency.

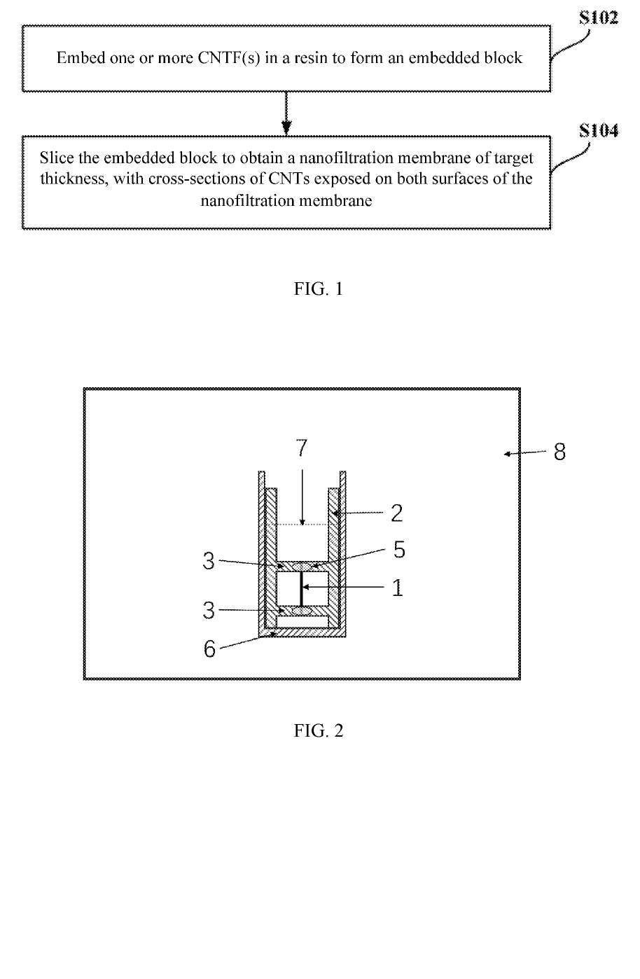

FIG. 1 is a flow diagram illustrating a method for fabricating a CNT-NM 14 based on CNTFs 1 according to an embodiment of the present invention. Referring to FIG. 1, the method at least includes the following steps S102–S104.

Step S102, embedding one or more CNTF(s) in a resin to form an embedded block.

Step S104, slicing the embedded block to obtain a nanofiltration membrane of target thickness, with cross-sections of CNTs exposed on both surfaces of the nanofiltration membrane.

The method provided by this embodiment achieves facile fabrication of a CNTF-NM 14 based on CNTFs 1 by first embedding the CNTFs 1 in the resin and then slicing the embedded block to obtain the membrane of the desired thickness.

A CNTF 1 is a macroscopic assemblage of CNTs, that is, hundreds of micrometers to millimeters long CNTs are held together by van-der-Waals forces to form a continuous thread which is tens of micrometers in diameter and meters (or even kilometers) in length. Every cross-section of the CNTF 1 contains a dense array of CNT pores that can act as entrance/exit ports for molecular transport. Thus, any short segment cut from the fiber already possesses the requisite inlet and outlet channels for membrane filtration. By embedding such a segment in an impermeable resin matrix, almost all trans-membrane transport occurs exclusively through the interior space of the CNTs. Exploiting the nanometer-scale inner diameter of the CNTs and close packing of the CNTs within the CNTF 1 yields a novel CNTF-NM 14. Because both surfaces of the sliced membrane expose CNT cross-sections, the CNTs are highly aligned and traverse the entire membrane thickness, markedly increasing the number of effective channels and thereby delivering high flux.

In some embodiments, step S102 may specifically include:

placing the one or more CNTF(s) 1 in a desired orientation in a container 6; and

adding the resin into the container 6 and curing it to embed the one or more CNTF(s) 1to obtain the embedded block 9.

The container 6 may be, for example, a cylindrical vessel. Of course, the container 6 may also be of other shapes such as spherical, conical, etc., selected according to practical requirements.

The desired orientation of the CNTF(s) 1 can be chosen as needed. For instance, the CNTF(s) may be placed in the container 6 in a linearly extended, helically wound, folded, braided, or twisted configuration. The CNTF(s) may be held in place with the aid of a frame or may be suspended directly in the container 6 without any fixing aid.

In some further embodiments, the step of placing the CNTF(s) 1 in the desired orientation in the container 6 may specifically include:

fixing the CNTF(s) 1 in a frame 2, with at least a portion of the CNTF(s) not in direct contact with the frame 2; and

inserting the frame 2 vertically into the container 6 along a longitudinal direction of the frame.

The material of the frame 2 may be chosen from easily machinable polymers that exhibit good affinity for the resin used during embedding and that can withstand moderate mechanical loads without significant deformation. In some specific embodiments, the frame 2 may be made of polyethylene terephthalate (PET) or a similar material. Of course, other materials may also be used for the frame 2, and the present invention imposes no particular limitation thereon.

In some embodiments, the CNTF(s) 1 is/are secured in the frame 2 by means of a fixing element 5. The fixing element 5 may be, for example, UV-curable adhesive (fixed by UV irradiation curing), transparent adhesive tape, clamps, and so on.

The lateral dimension of the container 6 should match that of the frame 2. To ensure that the frame 2 remains upright in the container 6 and thereby preserve the extended orientation of the CNTF(s) 1 during embedding, it is preferred that the lateral dimensions of the container 6 and the frame 2 are chosen so that the frame 2 fits snugly into the cylindrical container 6 and is held in place by the mutual interaction forces between the frame and the wall of the container, preventing tilting or collapse.

The cross-sectional shape of the container 6 may be selected according to the intended application of the membrane; for instance, it may be circular, polygonal, etc. The resin is better to filled into the container 6 to a height sufficient to completely immerse the CNTF(s) 1.

A wide range of resins may be selected. To facilitate curing and processing while minimizing any adverse effects of the curing process on the CNTF(s) 1, it is preferable to choose a resin that, before curing, exhibits high fluidity and, during curing, releases little heat and undergoes low shrinkage, while providing high hardness after cure. In some specific embodiments, the resin may be an epoxy resin such as Epon-812 or Spurr resin.

Curing temperature and time may be set according to the particular resin chosen. In some specific embodiments, after the resin has been poured into the container 6, the container is first heated to a first temperature (e.g. 50–60 °C) and held at this temperature for a first period (e.g. 20–30 h) to accomplish pre-cure; thereafter, the temperature is raised to a second temperature (higher than the first temperature, e.g. 65–80 °C) and held for a second period (e.g. 10–15 h) to complete the cure.

In some optional embodiments, the CNTF(s) 1 to be embedded may consist of a single CNTF 1.

In other optional embodiments, the CNTF(s) 1 may be in the form of an array composed of a plurality of CNTFs 1.

In yet further optional embodiments, the CNTF(s) 1 may be a bundle-like structure formed by twisting one or more CNTF(s) 1.

The embedding and slicing procedures for these different morphologies of CNTF(s) 1 are described below.

In some embodiments, when the CNTF(s) 1 is a single CNTF or an array of multiple CNTFs, the frame 2 is provided with one or more cross-beams 3, for example, two cross-beams.

At least a part of the single CNTF 1 or each individual CNTF 1 of the array is fixed to the cross-beams 3 so that the single CNTF 1 or each individual CNTF 1 of the array extends along the longitudinal direction of the frame 2.

In a specific embodiment, the frame 2 is configured with two cross-beams 3 arranged parallel to each other and spaced apart along the longitudinal direction of the frame. During embedding, the two ends of the single CNTF 1 or of each CNTF 1 in the array are fixed to the two cross-beams 3, respectively, so that the single CNTF 1 or each CNTF 1 in the array extends longitudinally along the frame 2.

In other embodiments, when the CNTF(s) 1 is(are) present as a bundle-like structure formed by twisting one or more individual CNTF 1, the bundle-like structure is fixed in the frame 2 with its longitudinal axis perpendicular to the longitudinal axis of the frame 2 prior to embedding.

FIG. 2 schematically illustrates the preparation of an embedded block 9 according to an embodiment of the present invention. In a specific example shown in FIG. 2, a single CNTF 1 is secured to a PET frame 2 by means of a fixing element, specifically an ultraviolet-curable adhesive 5. Both ends of the CNTF 1 are bonded to the two cross-beams 3 of the frame 2 with the UV adhesive 5, and the CNTF segment between the two cross-beams (i.e., within the open area of the frame 2) will subsequently be used for membrane formation. The outer width of the frame 2 is essentially equal to the inner diameter of the container 6, so that the frame can be inserted vertically into the container 6 without tilting. An appropriate amount of resin is added into the container 6 to reach level 7, after which the container 6 is transferred to an oven 8 for curing: pre-cure: 55 °C for 24 h, final cure: 70 °C for 12 h. Upon completion of the curing schedule, the embedded block 9 is ready for further processing.

FIG. 4 schematically illustrates an embodiment where an array composed of a plurality of CNTFs 1 is fixed in a frame 2. As shown in FIG. 4, one or more frames 2 may be used. When multiple frames 2 are employed, they are arranged parallel to one another and inserted vertically into the container 6 together. Each frame 2 can hold one or more rows of CNTFs 1.

FIG. 5 illustrates an embodiment in which a bundle-like structure formed by twisting one or more CNTFs 1 is fixed in a frame 2 and subsequently embedded. As shown in FIG. 5, the black coiled line represents the CNTF(s) 1, which are wound into a spindle-shaped bundle-like structure. This bundle-like structure is mounted transversely to the cross-beam of the frame 2 and may be positioned at any convenient location. In one optional embodiment, the bundle-like structure is secured at the lowest cross-beam 3 of the frame 2 (with “lowest” referring to the orientation of the frame 2 when it is standing vertically in the container). Specifically, a long CNT fiber is repeatedly wound around this cross-beam 3 to form the bundle-like structure, which makes bundle-like structure encloses the cross-beam 3.

It should be noted that, although FIG. 2 depicts only a single CNTF 1, the resin-injection and curing operations described therein are equally applicable to the other fiber morphologies discussed above (such as an array of multiple CNTFs 1 or a bundle-like structure obtained by twisting one or more CNTFs 1).

Slicing processes are adapted to different morphology of the CNTF(s) 1 and to the way they were mounted.

In some embodiments where the CNTF(s) 1 is(are) in the form of a single CNTF or an array of multiple CNTFs, the step of slicing the embedded block 9 includes stepwisely slicing the embedded block 9 with a cutting plane perpendicular to the axial direction of the CNTF(s) 1. The step length equals the target thickness of the nanofiltration membrane.

In some embodiments where the CNTF(s) 1 is(are) twisted into a bundle-like structure, the step of slicing the embedded block 9 includes stepwisely slicing the embedded block 9 with a cutting plane parallel to the longitudinal axis of the bundle-like structure. The step length is set to the target thickness of the nanofiltration membrane.

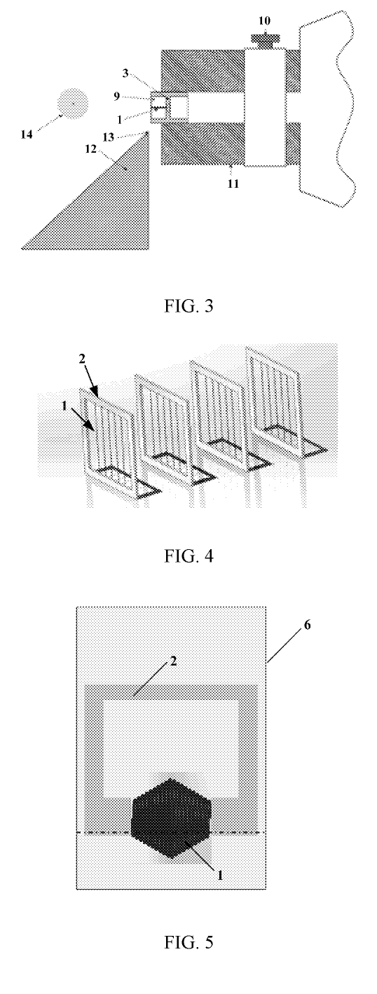

FIG. 3 schematically illustrates slicing of the embedded block 9 according to an embodiment of the present invention. In a specific example as shown in FIG. 3, a microtome is used to slice the embedded block 9 into films. Before slicing, the embedded block may be pre-trimmed to remove the cross-beam 3 at one longitudinal end of the frame 2, with only the opposite cross-beam 3 and the central region containing the CNTF(s) 1 being left, all of which will be sliced into the membranes, as shown in FIG. 3.

The trimmed embedded block 9 is clamped in a fixture 11 by means of a knob 10. A knife holder 12 is advanced so that a blade 13 approaches the embedded block 9. A motor (not shown) behind the fixture 11 drives the embedded block 9 to move vertically and horizontally; after each programmed advance, a cut is made. Once an intact film is cut from the embedded block by the blade 13, the step length is set to the desired value to obtain a CNTF-NM 14 of target thickness. The dark dot in the center of the membrane 14 shown in FIG. 3 represents the cross-sections of the cut CNTs.

Although FIG. 3 depicts only a single CNTF 1, persons skilled in the art will appreciate that the same slicing procedure is readily applicable to the other CNTF morphologies described herein—namely, an array of multiple CNTFs 1 or a bundle-like structure formed by twisting one or more CNTF(s) 1.

In optional embodiments involving the bundle-like structure, the blade is initially positioned at the dashed line indicated in FIG. 5 so that every slice contains the same number of CNT channels.

By embedding and then slicing either (i) an array of multiple CNTFs 1 or (ii) a twisted bundle of one or more CNTF(s) 1, the present invention multiplies the density of CNT pores on the cross-section of the membrane, further increasing the flux of the CNTF-NM 14.

Moreover, CNTFs 1 are routinely produced in lengths of tens of centimeters. Taking a membrane thickness of ~20 µm, a single CNTF can yield several thousand membranes by

serial slicing—an order-of-magnitude boost in productivity. In contrast, the vertical aligned CNT array route relies on enlarging the silicon wafer during growth, which places stringent demands on reactor uniformity and stability and is not a straightforward route to mass production.

In other embodiments the microtome may be replaced by an ultramicrotome or any other instrument capable of micrometer/nanometer-scale cutting.

The embed-and-slice strategy described herein is equally applicable to other fibrous materials; the dimensions of the container 6 and the shape and material of the frame 2 can be adapted to the target fibers and desired membrane characteristics.

In some embodiments, after the embedded block 9 has been sliced, the fabrication method further includes an extension step for the CNTF-NM 14.

Specifically, the extension step includes: selecting an extension membrane 15 made of a solvent-impermeable material and forming an aperture therein, the aperture being sized to fully expose the CNT cross-sections of the CNT-NM 14 while remaining smaller than the overall dimensions of the CNT-NM 14; and aligning the region of the CNT-NM 14 that contains the CNT cross-sections with the aperture and bonding the CNT-NM 14 to the extension membrane 15, thereby completing the extension of the CNT-NM 14.

The shape of the aperture may be chosen according to the shape of the CNT-NM 14 and/or the arrangement of the CNT cross-sections. For example, a circular aperture may be used for a nanofiltration membrane 14 derived from a single CNTF 1, whereas a rectangular aperture matching the CNTF array may be adopted for a nanofiltration membrane 14 containing an array of CNTFs 1. In one optional embodiment, a circular aperture is employed for ease of machining and bonding.

The material of the extension membrane 15 should be readily processable and impermeable to the solvent (e.g. water). In some specific embodiments, the extension membrane 15 may be made of at least one of PET, rubber, polyimide (PI), or any other material that can be easily formed into a film or sheet.

The CNT-NM 14 and the extension membrane 15 may be bonded together with an adhesive 16, for example, a UV-curable adhesive.

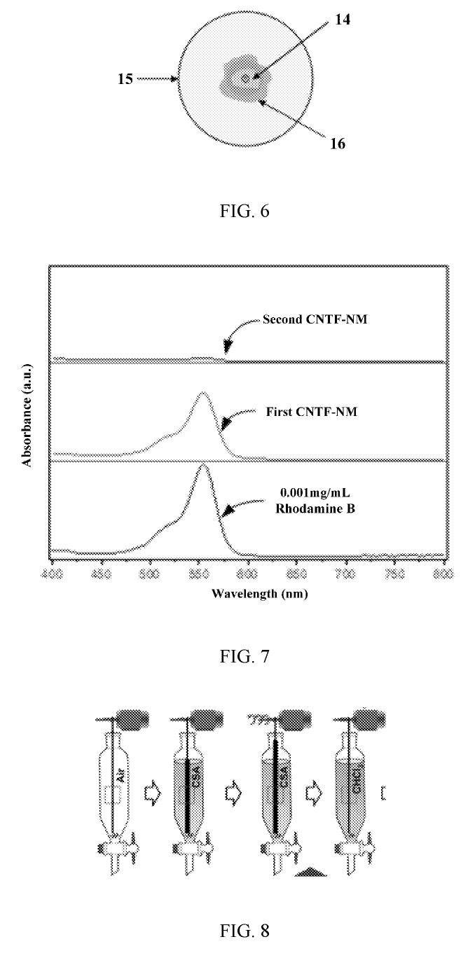

FIG. 6 is a schematic illustration of extending the CNT-NM 14 according to an embodiment of the present invention. In one specific embodiment shown in FIG. 6, when the CNT-NM 14 obtained by slicing is to be used, an extension membrane 15 made of PET is employed to extend the CNT-NM 14. An aperture with a diameter of 2 mm is formed in the PET extension membrane 15, the region of the CNT-NM 14 containing the CNT cross-sections is aligned with the aperture, and a UV-curable adhesive 16 is used as a bonding agent to bond and cure the CNT-NM 14 and the extension membrane 15, thereby completing the extension of the CNT-NM 14.

Because shear forces during slicing may prevent the CNT-NM 14 from being directly usable for mass transport, in some embodiments, after slicing the embedded block 9 or after extending the CNT-NM 14, a post-treatment step for the CNT-NM 14 may further be performed.

Specifically, the post-treatment step includes treating both surfaces of the CNT-NM 14 by reactive ion etching, ion milling, or focused ion beam cutting, thereby opening the pores of the CNTs within the exposed cross-sections so as to enable mass transport.

Reactive ion etching (RIE) can be performed under art-recognized conditions. In one embodiment, the RIE parameters are: a mixture of O₂ and Ar with a ratio of O₂ flow rate to Ar flow rate being 50 sccm: 20 sccm; power: 100 W; pressure: 100 mTorr; and treatment time per surface for 10 min.

In some embodiments, the cut-off size of the CNT-NM 14 is tuned by controlling the inner diameter distribution of the CNTs during manufacture of the CNTFs 1, thereby adjusting the selectivity of the nanofiltration membrane 14.

In some further embodiments, the CNTFs 1 are produced by FCCVD, array spinning, wet spinning, or film twisting.

In FCCVD or array spinning, the inner diameter of carbon nanotubes in the carbon-nanotube fibers is tuned by adjusting an effective size of catalyst particles during carbon nanotube growth.

In film twisting, CNT films having different inner diameters of carbon nanotubes are selected and twisted into fibers.

In wet spinning, the inner diameter of the CNTs could be tuned by selecting carbon nanotube raw materials of different diameters.

As mentioned above, the inner diameter of carbon nanotubes is tuned by varying the particle size of the catalyst in FCCVD.

In some further embodiments, the particle size of the catalyst can be changed by changing a feeding manner of the catalyst during FCCVD, so as to tune the inner diameter of carbon nanotubes.

In some other embodiments, the particle size of the catalyst can be changed by controlling a temperature profile in the growth zone of CNTs, the feed rate of a catalyst precursor; or the use of promoters, so as to tune the inner diameter of the resulting CNTs.

FIG. 7 compares the rejection of Rhodamine B (RhB) by nanofiltration membranes 14 prepared from CNTFs 1 synthesized with two different catalyst-feed strategies, wherein a first CNTF-NM is fabricated from CNTFs prepared by FCCVD at a "spray" catalyst-feed manner, while a second CNTF-NM is fabricated from CNTFs prepared by FCCVD at an "aerosol-blow" catalyst-feed manner.

The size of RhB molecules is approximately 1.59*1.18*0.56 nm. The cut-off size of the CNTF-NM is assessed by measuring the difference in absorbance between a feed solution (0.001 mg·mL⁻¹) upstream of the CNTF-NM and a permeated solution downstream of the CNTF-NM; the characteristic peak of RhB is used as the signature for detection.

Absorbance data in FIG. 7 shows that, for the second CNTF-NM, almost no RhB is detected in the permeated solution, indicating almost complete rejection of RhB. In contrast, the first CNTF-NM exhibits a clear RhB absorption peak in the permeated solution, demonstrating that a part of RhB has been transported through larger CNT channels of the CNTF-NM, and the first CNTF-NM has a poor rejection effect on RhB. The "aerosol-blow" catalyst-feed manner produces CNTs with smaller inner diameters (~1 nm), enabling the second CNTF-NM to block RhB effectively, whereas the "spray" catalyst-feed manner yields larger CNT inner diameters, resulting in poorer rejection of the first CNTF-NM on RhB.

Thus, compared with the prior nanofiltration membranes based on vertical aligned CNT arrays, the present invention can more effectively regulate the diameter (inner-diameter) distribution of the large number (hundreds of millions) of CNTs in CNTFs by means of different preparation techniques for CNTFs 1, and further uses the CNTFs 1 formed by CNTs of different diameters to prepare nanofiltration membranes, so that effective regulation of the selectivity of the nanofiltration membrane can be realized.

In some embodiments, the CNTFs 1 can be prepared directly by FCCVD direct spinning.

In other embodiments, the CNTFs 1 can also be prepared by dispersing CNT powder in a solution and then wet spinning.

Thus, the solution of the present invention has a larger regulation space for the inner diameter distribution of CNTs.

In some embodiments, prior to embedding the CNTF(s) 1 in the resin to form the embedded block 9, the method of the present invention further includes a drawing operation performed on the CNTF(s) 1.

The drawing operation includes drawing the CNTF(s) 1 to elongate a length thereof by a predetermined ratio of 10%–80%. Optionally, the predetermined ratio ranges from 10% to 80%, for example, 20%, 30%, 40%, 50%, 60% or 70%. Preferably, the predetermined ratio is 50%.

Those skilled in the art will appreciate that, when the CNTF(s)1 is(are) in the form of an array composed of a plurality of individual CNTFs or a bundle-like structure formed by twisting one or more CNTFs, the drawing operation is carried out on each individual CNTF within the array or the bundle-like structure.

FIG. 8 schematically illustrates the drawing process of the CNTF 1 according to an embodiment of the present invention. In the example shown in FIG. 8, the drawing operation of the CNTF 1 includes: immersing the CNTF 1 in chlorosulfonic acid for a first time of period (e.g., 20 seconds) and measuring an original length L of the CNTF in the first time of period; elongating the CNTF to x times the original length L, where x = 1 + predetermined ratio, for example, x = 1.5 for 50% elongation; removing the chlorosulfonic acid and immersing the CNTF in chloroform for a second time of period (for example, about 1 minute) to extract residual chlorosulfonic acid; and sequentially replacing the chloroform with ethanol, water and acetone to remove chloroform and other impurities from the CNTF 1, thereby completing both drawing and cleaning of the CNTF 1.

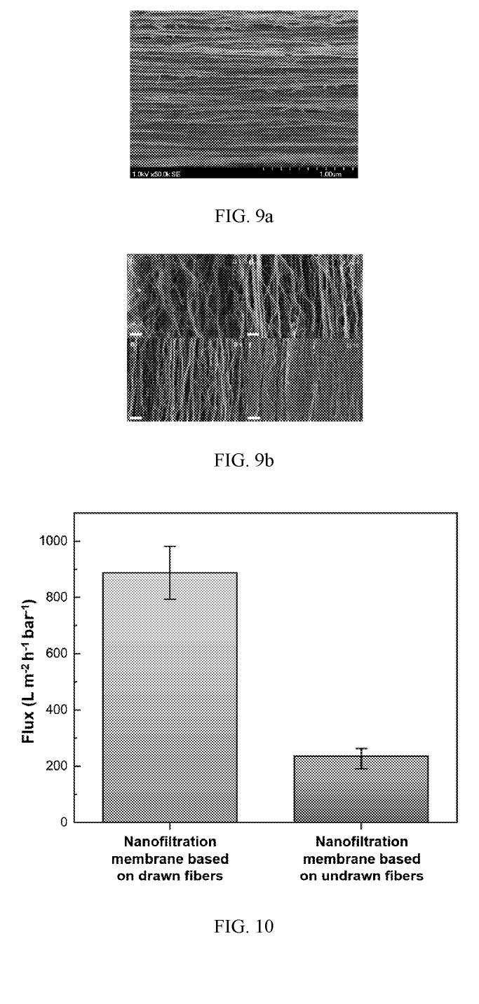

FIGS. 9a and 9b are SEM images of a drawn CNTF 1 of the present invention (FIG. 9a) and CNT bundles of a vertically aligned array in the prior art (FIG. 9b), respectively. It can be seen that the drawn CNTF 1 in FIG. 9a exhibits markedly lower CNT tortuosity, whereas the array in FIG. 9b shows pronounced waviness of CNT bundles.

FIG. 10 compares the water flux of nanofiltration membranes 14 prepared from the same CNTF 1 before and after drawing. As seen from FIG. 10, the flux of the nanofiltration membrane prepared from the drawn CNTF 1 increases four-fold compared with that of the nanofiltration membrane prepared from the undrawn CNTF 1. The water flux of the nanofiltration membrane prepared from the drawn CNTF reaches 800 L·m⁻²·h⁻¹·bar⁻¹ at 0.03 MPa.

By drawing the CNTF(s) 1 before embedding the same, the CNT tortuosity of the CNTF(s) is further reduced during drawing, and the packing density of CNTs is increased to improve the areal density thereof, leading to an increase in the flux of the nanofiltration membrane. In addition, the increase of packing density could also prevent difficulty in filling a large number of gaps among the CNTs in the CNTF(s) 1, which shows remarkable advantages over the prior nanofiltration membrane with vertically aligned CNT arrays as raw materials.

Based on the same technical concept, the present invention further provides a nanofiltration membrane 14 based on CNTFs 1, produced by the method described above.

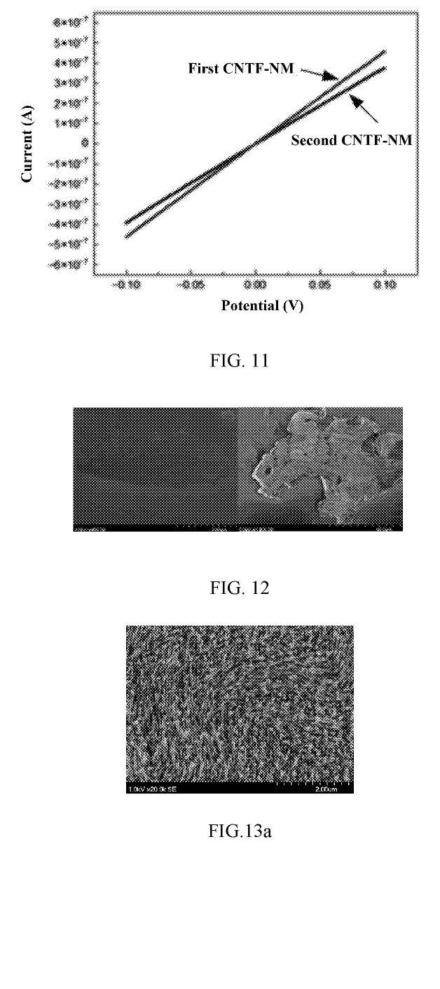

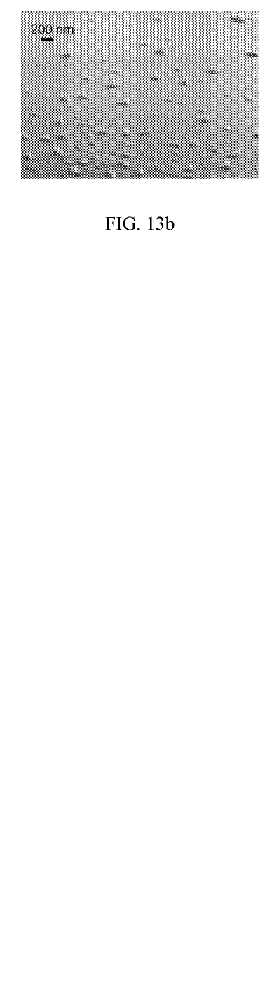

FIG. 11 shows the trans-membrane ionic conductance of the CNTF-NM 14 according to an embodiment of the present invention. FIG. 12 shows surface SEM images of the CNTF-NM 14 according to an embodiment of the present invention. FIGS. 13a and 13b are surface SEM images showing the areal density of the nanofiltration membrane based on CNTFs according to an embodiment of the present invention and of a nanofiltration membrane prepared from a CNT dispersion of the prior art, respectively.

By using the ionic conductance data of FIG. 11 and the membrane area observed in FIG. 12, the CNT areal densities of the first CNTF-NM and the second CNTF-NM are calculated to be 1.94× 10¹¹ cm⁻² and 5.23 × 10¹¹ cm⁻² respectively, both of which are markedly higher than those of membranes derived from vertical aligned CNT arrays.

As seen in FIGS. 13a and 13b, the CNT areal density of the CNTF-NM 14 produced from CNTFs 1 is significantly greater than that of membranes fabricated from CNT dispersions.

The nanofiltration membrane based on CNTFs of the present invention is suitable for rejecting solutes with a particle size ≥ 1.3 nm; and the exact cut-off size of the nanofiltration membrane can be shifted by choosing a different CNTF type. In a free-standing configuration, the nanofiltration membrane can withstand 0.06 MPa continuously and operate safely at 10-50 °C.

Because the nanofiltration membrane of the present invention only needs a relatively low filtration pressure, the water flux of the nanofiltration membrane is up to 800 L·m⁻²·h⁻¹·bar⁻¹ at only 0.03 MPa. This makes it ideal for field use where high pressures cannot be generated, so as to obtain virus-free purified drinking water. Current life-straws adopting a hollow-fiber ultrafiltration membrane at the highest filtration stage cannot remove nano-sized viruses existing in field water, while current commercial nanofiltration membranes require a pressure of 0.6-1 MPa, which is unachievable in the field. The low-pressure driven, high-flux CNT nanofiltration membrane of the present invention only requires an operating pressure of about 0.02 MPa, which is equivalent to a pressure generated by human suction, and is therefore well-suited for the next generation of life-straw devices.

Additionally, the CNTF nanofiltration membrane fabricated according to the present invention exhibits excellent flexibility, enabling it to conform to irregular surfaces and further control the substances entering or exiting such surfaces. This characteristic opens prospective applications in artificial kidneys or in any scenario requiring emulation of human organs.

In the following description, numerous specific details are set forth. Embodiments of the present invention may, however, be practiced without some or all of these details. In some examples, well-known methods, structures and techniques have not been described in detail so as not to obscure the present disclosure.

So far, those skilled in the art should recognize that although various exemplary embodiments of the present invention have been shown and described in detail herein, many other variations or modifications consistent with the principles of the present invention still can be directly determined or derived according to the disclosed contents of the present invention without departing from the spirit and scope of the present invention. Therefore, the scope of the present invention should be understood and recognized as covering all these other variations or modifications.

What is claimed is:

1. A method for fabricating a nanofiltration membrane based on carbon-nanotube fibers, comprising:
embedding one or more carbon-nanotube fibers in a resin to form an embedded block, and
slicing the embedded block to obtain a nanofiltration membrane of target thickness, with cross-sections of carbon nanotubes exposed on both surfaces of the nanofiltration membrane.

2. The method of claim 1, wherein the step of embedding one or more carbon-nanotube fibers in a resin to form an embedded block comprises:
placing the one or more carbon-nanotube fibers in a desired orientation in a container; and
adding the resin into the container and curing it to embed the one or more carbon-nanotube fibers to obtain the embedded block.

3. The method of claim 2, wherein the step of placing the one or more carbon-nanotube fibers in a desired orientation in a container comprises:
fixing the one or more carbon-nanotube fibers in a frame with at least a portion of the one or more carbon-nanotube fibers being not in direct contact with the frame; and
inserting the frame vertically into the container along a longitudinal direction of the frame.

4. The method of claim 3, wherein the one or more carbon-nanotube fibers are in a form of a single carbon-nanotube fiber, an array formed by a plurality of carbon-nanotube fibers, or a bundle-like structure formed by twisting one or more carbon-nanotube fibers.

5. The method of claim 4, wherein in a case that the one or more carbon-nanotube fibers are in the form of the single carbon-nanotube fiber or the array formed by a plurality of carbon-nanotube fibers, the frame has a cross-beam, and at least a part of the single carbon-nanotube fiber or of each carbon-nanotube fiber of the array is fixed on the cross-beam so that the single carbon-nanotube fiber or each carbon-nanotube fiber of the array extends along the longitudinal direction of the frame;
wherein a step of slicing the embedded block comprises:
performing stepwise slicing on the embedded block with a cutting plane perpendicular to an axial direction of the carbon-nanotube fiber, with a step length being the target thickness of the nanofiltration membrane.

6. The method of claim 4, wherein in a case that the one or more carbon-nanotube fibers are in the form of the bundle-like structure, the bundle-like structure is fixed in the frame with an axial direction of the bundle-like structure being perpendicular to the longitudinal direction of the frame;
wherein a step of slicing the embedded block comprises:
performing stepwise slicing on the embedded block with a cutting plane parallel to an axial direction of the bundle-like structure, with a step length being the target thickness of the nanofiltration membrane.

7. The method of claim 1, after slicing the embedded block, further comprising:
selecting an extension membrane made of a solvent-impermeable material, and forming an aperture in the extension membrane, a size of the aperture being large enough to fully expose the cross-sections of the carbon nanotubes in the nanofiltration membrane and smaller than a size of the nanofiltration membrane; and
aligning the cross-sections of the carbon nanotubes in the nanofiltration membrane with the aperture, and bonding the nanofiltration membrane to the extension membrane to complete extension of the nanofiltration membrane.

8. The method of claim 1, further comprising:
treating both surfaces of the nanofiltration membrane by reactive ion etching, ion milling, or focused ion beam cutting.

9. The method of claim 1, wherein the carbon-nanotube fibers are prepared by floating catalyst chemical vapor deposition, array spinning, wet spinning, or film-twisting;
wherein, in floating catalyst chemical vapor deposition or array spinning, an inner diameter of carbon nanotubes in the carbon-nanotube fibers is tuned by adjusting an effective size of catalyst particles during carbon nanotube growth;
wherein, in film-twisting, carbon-nanotube films with different inner diameters of carbon nanotubes are selected and twisted into the carbon-nanotube fibers;
wherein, in wet spinning, the inner diameter of carbon nanotubes is tuned by selecting carbon nanotube raw materials of different diameters.

10. The method of claim 1, before embedding the one or more carbon-nanotube fibers in the resin, further comprising:
drawing the one or more carbon-nanotube fibers to elongate a length thereof by a predetermined ratio of 10%–80%.

11. A nanofiltration membrane based on carbon-nanotube fibers fabricated by the method of claim 1.
